(19) United States
(12) Patent Application Publication
(10) Pub. No.: US 2024/0275098 A1
(43) Pub. Date: Aug. 15, 2024

(54) TERMINAL FITTING

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yasunori ASANO, Mie (JP); Yutaka KOBAYASHI, Mie (JP)

(21) Appl. No.: 18/567,015

(22) PCT Filed: Jun. 2, 2022
(86) PCT No.: PCT/JP2022/022412

§ 371 Date: Dec. 4, 2023

(30) Foreign Application Priority Data
Jun. 23, 2021 (JP) 2021-104181

(51) Int. Cl. H01R 13/11; H01R 13/41

(52) U.S. Cl. CPC H01R 13/11; H01R 13/41

(57) ABSTRACT

Opening from a seam of a hollow cylindrical portion of a terminal fitting can be suppressed. A terminal fitting (10) is provided with a hollow cylindrical portion (20) and a plurality of resilient contact pieces (31) cantilevered from the hollow cylindrical portion (20). The hollow cylindrical portion (20) is formed by bending a plate material such that a second seam (22) is exposed on an outer peripheral surface. The hollow cylindrical portion (20) includes a first part (24) and a second part (25) adjacent across the second seam (22). The first part (24) is provided with an opening preventing portion (50) in contact with an outer surface of the second part (25).

### TECHNICAL FIELD

The present disclosure relates to a terminal fitting.

### BACKGROUND

A terminal fitting of Patent Document 1 is provided with a hollow cylindrical part circumferentially curved by press-working and having end surfaces butted against each other.

### PRIOR ART DOCUMENT

### Patent Document

Patent Document 1: JP 2011-165321 A

### SUMMARY OF THE INVENTION

### Problems to be Solved

However, in the hollow cylindrical part of Patent Document 1, the end surfaces butted against each other may move outward to open the hollow cylindrical part. As a result, a contact load may become weak or the terminal fitting may be set in an unintended connection posture at the time of connecting the terminal fitting to a mating terminal, whereby connection reliability may be reduced.

The present disclosure was completed on the basis of the above situation and aims to suppress opening from a seam of a hollow cylindrical portion of a terminal fitting.

### Means to Solve the Problem

The present disclosure is directed to a terminal fitting with a hollow cylindrical portion and a plurality of resilient contact pieces cantilevered from the hollow cylindrical portion, the hollow cylindrical portion being formed by bending a plate material such that a seam is exposed on an outer peripheral surface, the hollow cylindrical portion including two parts adjacent across the seam, and one of the parts being provided with an opening preventing portion in contact with or closely facing an outer surface of the other part.

### Effect of the Invention

According to the present disclosure, it is possible to suppress opening from a seam of a hollow cylindrical portion of a terminal fitting.

### BRIEF DESCRIPTION OF THE DRAWINGS

FIG. 1 is a perspective view of a terminal fitting in one embodiment.

FIG. 2 is a front view of the terminal fitting.

FIG. 3 is a back view of the terminal fitting.

FIG. 4 is a right side view of the terminal fitting.

FIG. 5 is a plan view of the terminal fitting.

FIG. 6 is an enlarged view enlargedly showing a hollow cylindrical portion of the terminal fitting of FIG. 1 and the periphery thereof.

FIG. 7 is a section along A-A of FIG. 5.

FIG. 8 is a section along B-B of FIG. 2.

FIG. 9 is a perspective view showing a step of joining a first part to a second part in a manufacturing process of the terminal fitting.

FIG. 10 is a section, corresponding to FIG. 8, in the terminal fitting of FIG. 9.

FIG. 11 is a perspective view showing the terminal fitting assembled with a housing.

FIG. 12 is a section of the housing and the terminal fitting of FIG. 11 when viewed from a back surface side.

FIG. 13 is an enlarged view enlargedly showing a hollow cylindrical portion of a terminal fitting in another embodiment.

### DETAILED DESCRIPTION TO EXECUTE THE INVENTION

### Description of Embodiments of Present Disclosure

First, embodiments of the present disclosure are listed and described.

(1) The terminal fitting of the present disclosure is provided with a hollow cylindrical portion and a plurality of resilient contact pieces cantilevered from the hollow cylindrical portion, the hollow cylindrical portion being formed by bending a plate material such that a seam is exposed on an outer peripheral surface, the hollow cylindrical portion including two parts adjacent across the seam, and one of the parts being provided with an opening preventing portion in contact with or closely facing an outer surface of the other part.

According to the configuration of the present disclosure, the opening preventing portion provided on the one part of the hollow cylindrical portion is in contact with or closely facing the outer surface of the other part adjacent to the one part across the seam. Thus, a radially outward displacement of the other part is suppressed by the contact of the other part of the hollow cylindrical portion with the opening preventing portion. Therefore, opening from the seam of the hollow cylindrical portion can be suppressed.

(2) Preferably, the terminal fitting is assembled with a housing, and the opening preventing portion is bent when viewed from an axial direction of the hollow cylindrical portion.

According to this configuration, the stiffness of the opening preventing portion can be enhanced. Thus, a radially outward displacement of the other part is further suppressed by the contact of the opening preventing portion having a high stiffness with the other part of the hollow cylindrical portion. Therefore, the opening from the seam of the hollow cylindrical portion can be further suppressed.

(3) Preferably, the opening preventing portion is inserted into a groove portion provided in the housing in assembling the terminal fitting with the housing.

According to this configuration, the rotation of the terminal fitting with respect to the housing can be prevented.

(4) Preferably, the opening preventing portion includes an inclined portion inclined with respect to the outer surface of the other part.

According to this configuration, a position where the opening preventing portion contacts the outer surface of the other part is easily determined as compared to a configuration in which the opening preventing portion is in surface contact with the outer surface of the other part with a parallel surface. Thus, a shape variation of the terminal fitting can be reduced.

(5) Preferably, the opening preventing portion is provided with a protrusion configured to bite into the outer surface of the other part.

According to this configuration, the opening preventing portion and the other part are hardly shifted in position and a radially outward displacement of the other part is further suppressed. Thus, the opening from the second seam of the hollow cylindrical portion can be further suppressed.

(6) Preferably, the opening preventing portion rises to a position near a tip of a mating terminal in contact with the resilient contact pieces in an axial direction of the hollow cylindrical portion.

According to this configuration, an impedance around the hollow cylindrical portion can be changed by the opening preventing portion. Thus, impedance matching can be achieved between parts of the terminal fitting adjacent to the mating terminal and other parts not adjacent to the mating terminal.

(7) Preferably, the terminal fitting is assembled with a housing, and a projection to be press-fit into the housing is provided on an outer surface of the one part or an outer surface near the one part in the hollow cylindrical portion.

According to this configuration, the one part of the hollow cylindrical portion hardly moves radially outward by the projection being press-fit into the housing. Thus, a contact state of the opening preventing portion with the other part is easily maintained and a radially outward displacement of the other part is further suppressed. Therefore, the opening from the second seam of the hollow cylindrical portion can be further suppressed.

### DETAILS OF EMBODIMENTS OF PRESENT DISCLOSURE

### Embodiment

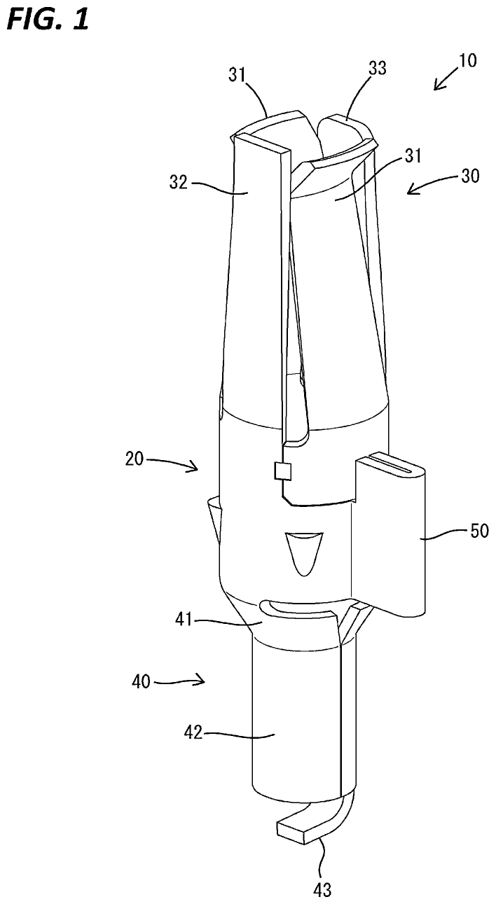

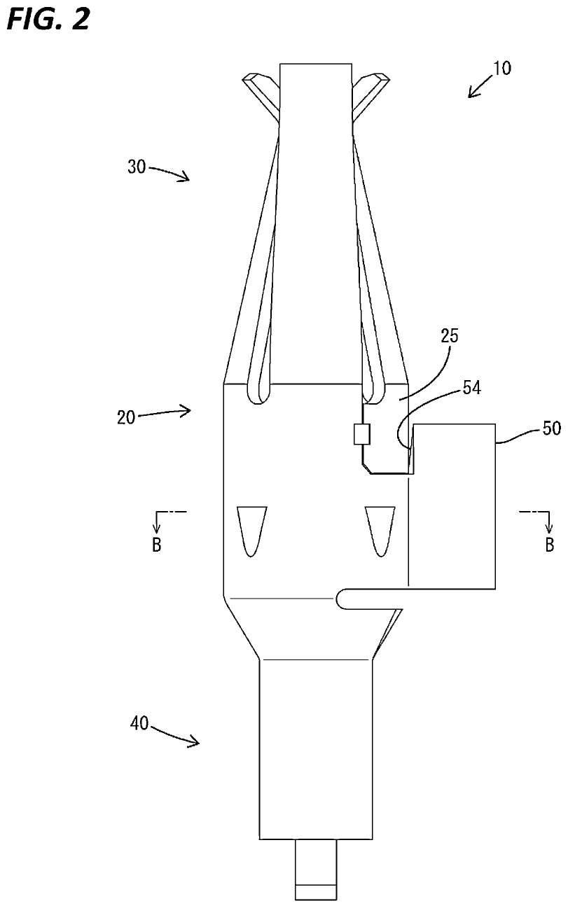

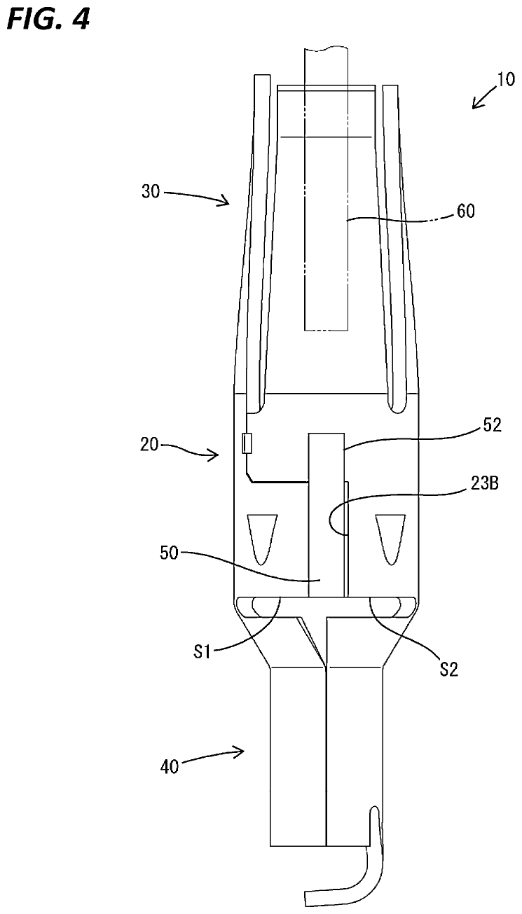

One specific embodiment of a terminal fitting of the present disclosure is described with reference to FIGS. 1 to 12. In this embodiment, upper and lower sides shown in FIGS. 1 to 4, 6, 7, 9, 11 and 12 are directly defined as upper and lower sides concerning a vertical direction. Left and right sides shown in FIG. 4 are respectively defined as front and rear sides concerning a front-rear direction. Left and right sides shown in FIGS. 2, 5, 8 and 10 are directly defined as left and right sides concerning a lateral direction.

### (Configuration of Terminal Fitting)

As shown in FIG. 1, a terminal fitting 10 of this embodiment is a female terminal fitting. The terminal fitting 10 is a single component made of a metal material. The terminal fitting 10 is formed, such as by press-working and bending an electrically conductive metal plate. The terminal fitting 10 has an elongated cylindrical shape as a whole. The terminal fitting 10 is provided with a hollow cylindrical portion 20, a connecting portion 30 and a mounting portion 40.

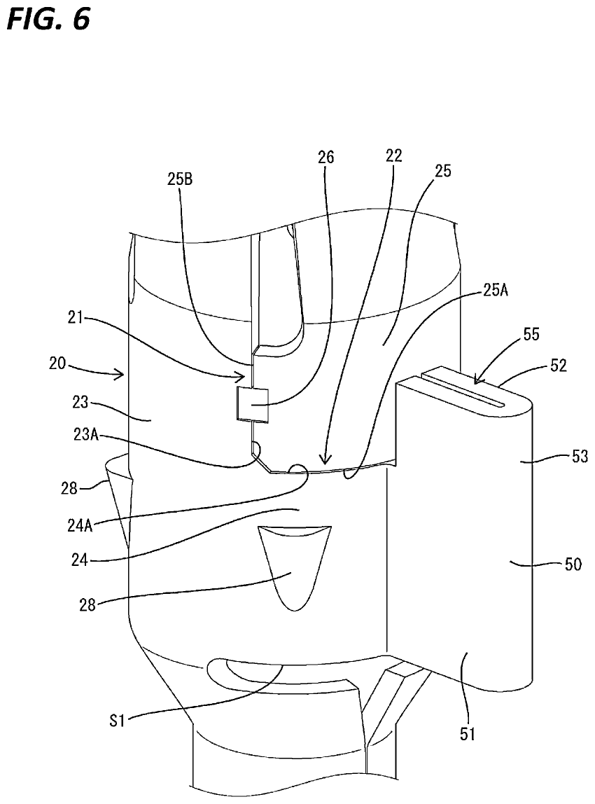

As shown in FIG. 1, the hollow cylindrical portion 20 constitutes an axial central part of the terminal fitting 10. The hollow cylindrical portion 20 is formed by bending a plate material in a circumferential direction. As shown in FIG. 6, a first seam 21 and a second seam 22 are exposed on the outer peripheral surface of the hollow cylindrical portion 20. The first seam 21 is parallel to an axial direction. The second seam 22 is along the circumferential direction. The second seam 22 corresponds to a “seam” of the present disclosure.

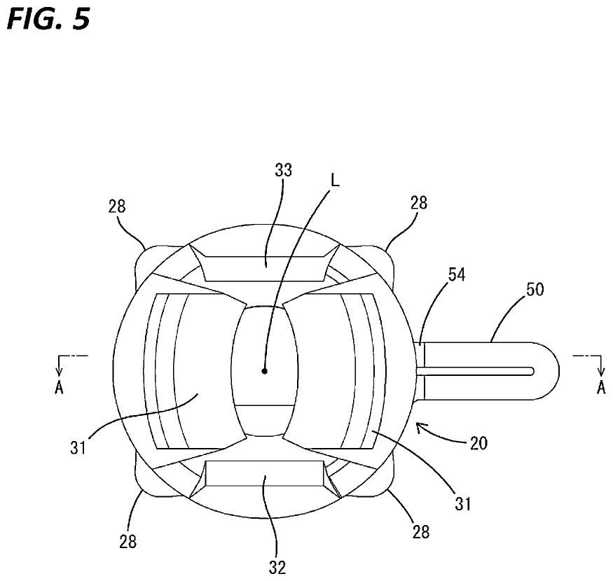

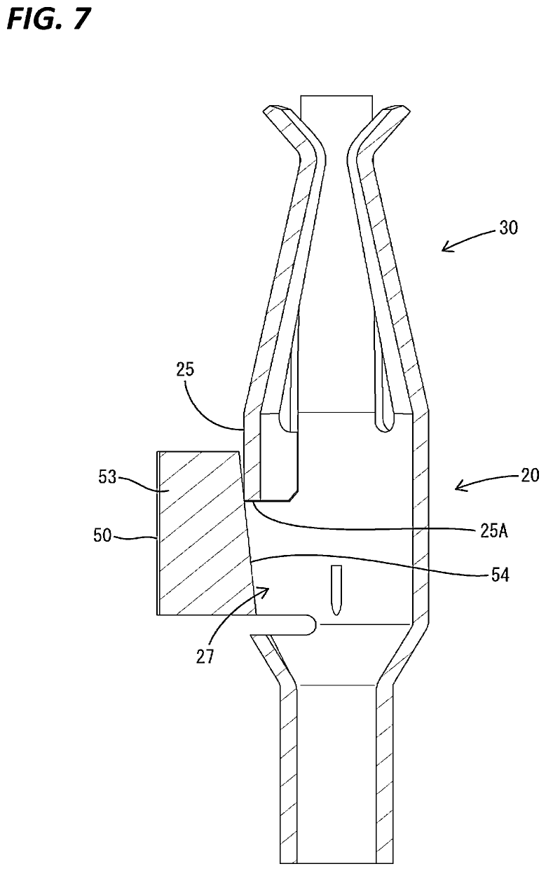

The connecting portion 30 is a part to be connected to a mating terminal 60 (see FIG. 4). As shown in FIG. 1, the connecting portion 30 includes a pair of resilient contact pieces 31 and a pair of slide pieces 32, 33. The pair of resilient contact pieces 31 and the pair of slide pieces 32, 33 are cantilevered from the hollow cylindrical portion 20. The pair of resilient contact pieces 31 and the pair of slide pieces 32, 33 are arranged side by side at intervals in the circumferential direction. The pair of resilient contact pieces 31 are arranged to face each other across an axis L (see FIG. 5). As shown in FIG. 7, the resilient contact piece 31 extends obliquely inward from the upper end of the hollow cylindrical portion 20 and further extends obliquely outward. The slide piece 32, 33 guides the insertion of the mating terminal 60 (see FIG. 4) into the connecting portion 30. The slide pieces 32, 33 are arranged to face each other across the axis L (see FIG. 5). The slide piece 32, 33 is in the form of a rectangular plate as shown in FIGS. 1 to 3. Both corners of the tip of the slide piece 32 are angular. Both corners of the tip of the slide piece 33 are rounded.

The mounting portion 40 is, for example, connected to a printed circuit (not shown) of a circuit board. As shown in FIG. 1, the mounting portion 40 includes a tapered portion 41, a peripheral wall portion 42 and a leg portion 43. The tapered portion 41 has a truncated conical shape connecting the lower end of the hollow cylindrical portion 20 and the upper end of the peripheral wall portion 42. The peripheral wall portion 42 has a hollow cylindrical shape. The leg portion 43 projects downward from the lower end of the peripheral wall portion 42. The leg portion 43 is in the form of a plate bent into an L shape.

As shown in FIG. 6, the hollow cylindrical portion 20 includes a body portion 23, a first part 24 and a second part 25. The first part 24 corresponds to “one part” of the present disclosure. The second part 25 corresponds to an “other part” of the present disclosure. The body portion 23 has an arc shape when viewed from the axial direction. A width in the axial direction of the body portion 23 is constant in the circumferential direction. The first part 24 is in the form of a plate extending in the circumferential direction from one circumferential end of the body portion 23. A width in the axial direction of the first part 24 is smaller than that of the body portion 23. The first part 24 has an arc shape when viewed from the axial direction. A first edge part 23A extending in the axial direction is provided on an upper end side part (part not provided with the first part 24) of the one circumferential end of the body portion 23.

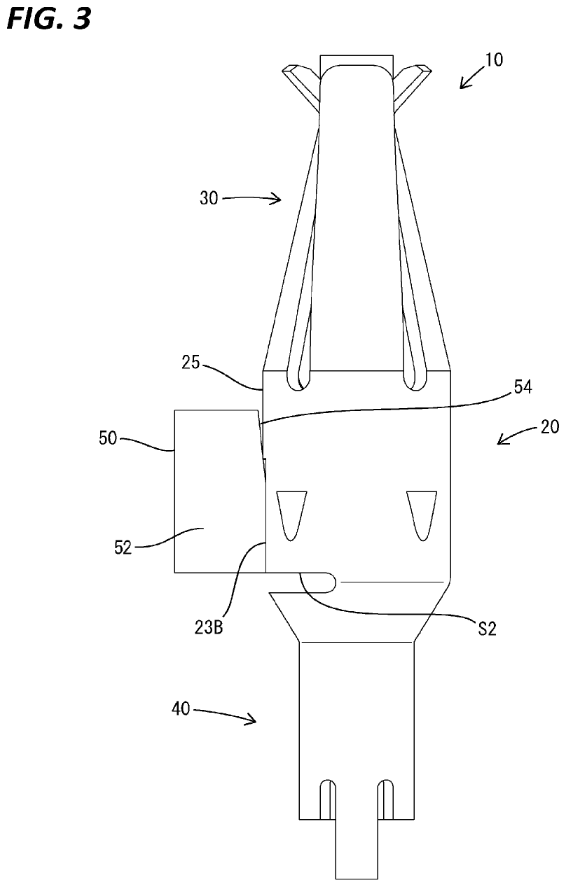

As shown in FIG. 6, the second part 25 is in the form of a plate extending in the circumferential direction from the other circumferential end of the body portion 23. A width in the axial direction of the second part 25 is smaller than that of the body portion 23. The second part 25 has an arc shape when viewed from the axial direction. A second edge part 23B (see FIGS. 3 and 4) extending in the axial direction is provided on a lower end side part (part not provided with the second part 25) of the other circumferential end of the body portion 23.

As shown in FIGS. 3, 4 and 6, a pair of arcuate slits S1, S2 along the circumferential direction are provided between the hollow cylindrical portion 20 and the tapered portion 41 of the mounting portion 40. The slit S1 extends further toward the body portion 23 than the base end of the first part 24. The slit S2 has almost the same length as the slit S1 and extends toward a side opposite to the slit S1.

The first and second parts 24, 25 are adjacent across the second seam 22 as shown in FIG. 6. The first and second parts 24, 25 overlap in the vertical direction. An upper end 24A of the first part 24 and a lower end 25A of the second part 25 contact in the axial direction to constitute the second seam 22.

As shown in FIG. 6, a tip 25B of the second part 25 and the first edge part 23A contact to constitute the first seam 21. The tip 25B of the second part 25 is in contact with the first edge part 23A in the circumferential direction. A crimping portion 26 is provided between the tip 25B of the second part 25 and the first edge part 23A. The crimping portion 26 is formed by welding the tip 25B of the second part 25 and the first edge part 23A.

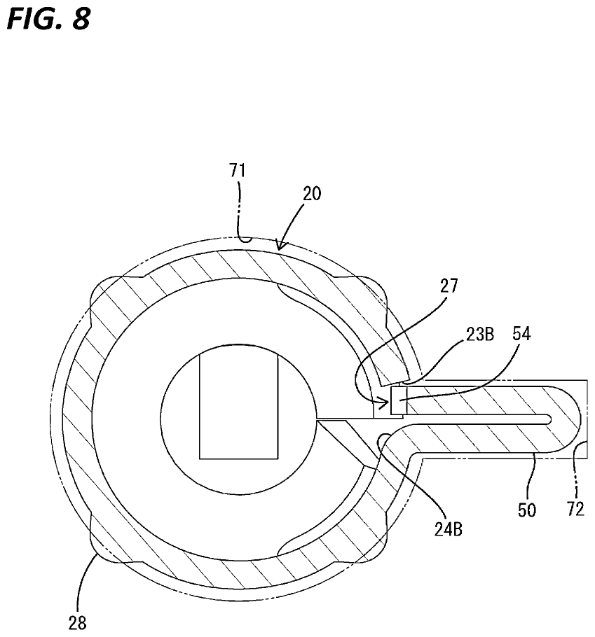

As shown in FIG. 8, a gap 27 is provided between a tip 24B (end part in an extending direction) of the first part 24 and the second edge part 23B of the body portion 23. The gap 27 is in the form of a slit long in the axial direction.

As shown in FIG. 6, the first part 24 is provided with an opening preventing portion 50. The opening preventing portion 50 prevents opening from the second seam 22 of the hollow cylindrical portion 20. The opening preventing portion 50 rises radially outward from the tip 24B (see FIG. 8) of the first part 24. A width in the axial direction of the opening preventing portion 50 is larger than that of the first part 24. The opening preventing portion 50 is formed by folding a plate part wider (wider in the axial direction) than the first part 24. The opening preventing portion 50 is bent into a U shape when viewed from the axial direction to be convex radially outward. Thus, the stiffness of the opening preventing portion 50 can be enhanced.

As shown in FIG. 6, the opening preventing portion 50 includes a first plate portion 51, a second plate portion 52 and a bent portion 53. The opening preventing portion 50 is connected to the first part 24 in the order of the first plate portion 51, the bent portion 53 and the second plate portion 52. The first plate portion 51 is in the form of a rectangular plate. The second plate portion 52 is in the form of a trapezoidal plate having an inclined portion 54 (see FIG. 7) on a tip (end part on a side opposite to the bent portion 53). The inclined portion 54 is inclined with respect to the outer surface (axial direction) of the second part 25 as shown in FIG. 7. The inclined portion 54 is inclined downward toward a radially inner side of the second part 25. One plate surface of the first plate portion 51 and one plate surface of the second plate portion 52 are facing each other in the circumferential direction. The bent portion 53 is bent to be convex radially outward.

As shown in FIG. 6, the opening preventing portion 50 is provided with a projecting portion 55 projecting further upward (toward the connecting portion 30) than the first part 24. The projecting portion 55 constitutes an upper end side part of the opening preventing portion 50. The projecting portion 55 is facing the outer surface of the second part 25. As shown in FIG. 4, the projecting portion 55 rises to a position near the tip of the mating terminal 60 in contact with the resilient contact pieces 31 (position slightly below the tip of the mating terminal 60) in the axial direction. In this way, an impedance around the hollow cylindrical portion 20 can be changed by the opening preventing portion 50. Thus, impedance matching can be achieved between parts of the terminal fitting 10 adjacent to the mating terminal 60 and other parts.

As shown in FIGS. 2 and 7, the opening preventing portion 50 is in contact with the outer surface of the second part 25. As shown in FIGS. 7 and 8, a lower end side of the inclined portion 54 of the second plate portion 52 enters the gap 27 from outside. As shown in FIGS. 3 and 7, the inclined portion 54 is in contact with the outer surface of a lower edge part of the second part 25. A radially outward displacement of the second part 25 is suppressed by the contact of the second part 25 of the hollow cylindrical portion 20 with the opening preventing portion 50. Thus, the opening from the second seam 22 of the hollow cylindrical portion 20 can be suppressed. Particularly, since the stiffness of the opening preventing portion 50 is enhanced by a bent shape, the opening from the second seam 22 of the hollow cylindrical portion 20 can be further suppressed.

An impedance of the terminal fitting 10 can be adjusted by changing a projection width in a radially outward direction, a width in the axial direction and the like of the opening preventing portion 50.

The inclined portion 54 is obliquely in contact with the outer surface of the second part 25. Thus, a position where the opening preventing portion 50 contacts the outer surface of the second part 25 is easily determined as compared to a configuration in which the opening preventing portion 50 is in surface contact with the outer surface of the second part 25 with a parallel surface. In this way, a shape variation of the terminal fitting 10 can be reduced.

As shown in FIGS. 5 and 6, four projections 28 are provided on the outer surface of the hollow cylindrical portion 20. The projections 28 are press-fit into a housing 70 to be described later. The projections 28 are arranged at equal intervals along the outer periphery of the hollow cylindrical portion 20. The projections 28 protrude in external directions. The projections 28 are formed, for example, by striking. One of the projections 28 is provided near a center of the first part 24.

### (Assembly of Terminal Fitting)

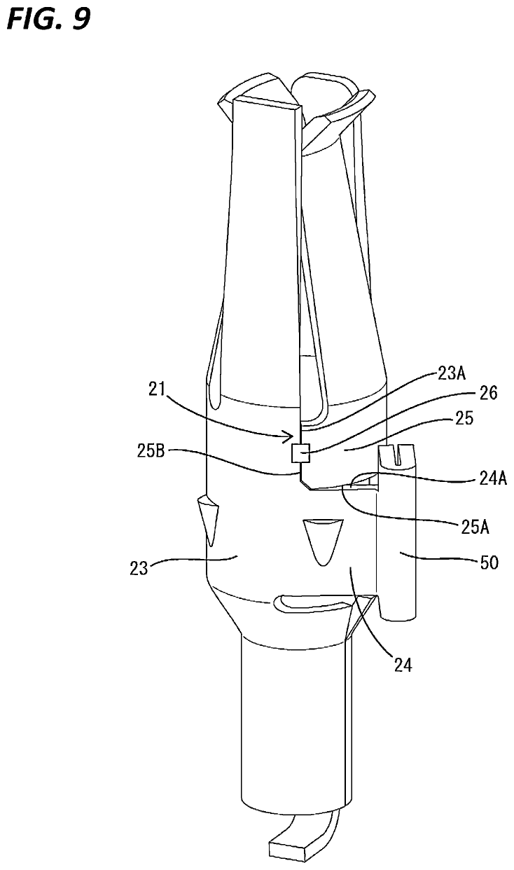

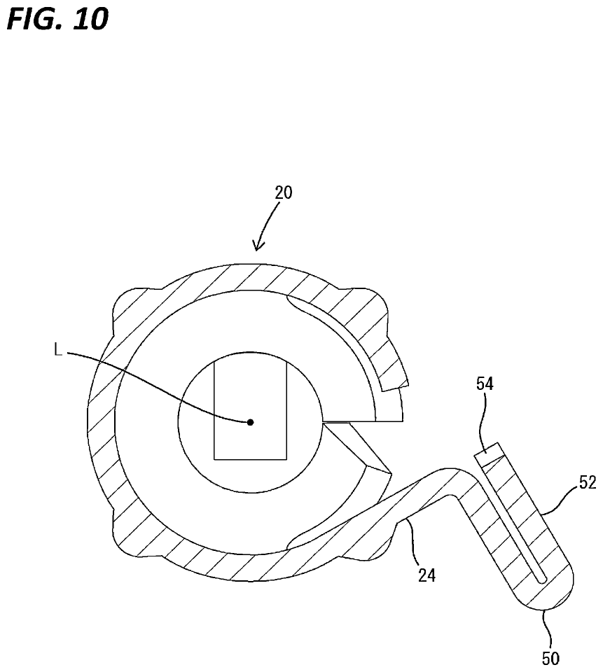

The electrically conductive metal plate is formed into an elongated cylindrical shape as shown in FIGS. 9 and 10, such as by press-working and bending. Specifically, the first edge part 23A of the body portion 23 and the tip 25B of the second part 25 are joined to form the first seam 21. Subsequently, the first seam 21 is welded to form the crimping portion 26. Here, the upper end 24A of the first part 24 is located radially outwardly of the lower end 25A of the second part 25 and the second seam 22 is not formed. As shown in FIG. 10, the inclined portion 54 of the second part 52 is not inserted in the gap 27 (see FIG. 8).

From a state shown in FIGS. 9 and 10, the first part 24 is bent inwardly (toward the axis L) to form the hollow cylindrical portion 20. Specifically, the upper end 24A of the first part 24 is opposed to the lower end 25A of the second part 25 to form the second seam 22 as shown in FIG. 6. As the second seam 22 is formed, the opening preventing portion 50 is brought into contact with the outer surface of the second part 25. Specifically, a lower end side part of the inclined portion 54 of the second plate portion 52 is inserted into the gap 27 (see FIG. 8) from outside. In this way, the inclined portion 54 comes into contact with the outer surface of the lower edge part of the second part 25.

(Assembly Structure of Terminal Fitting with Housing)

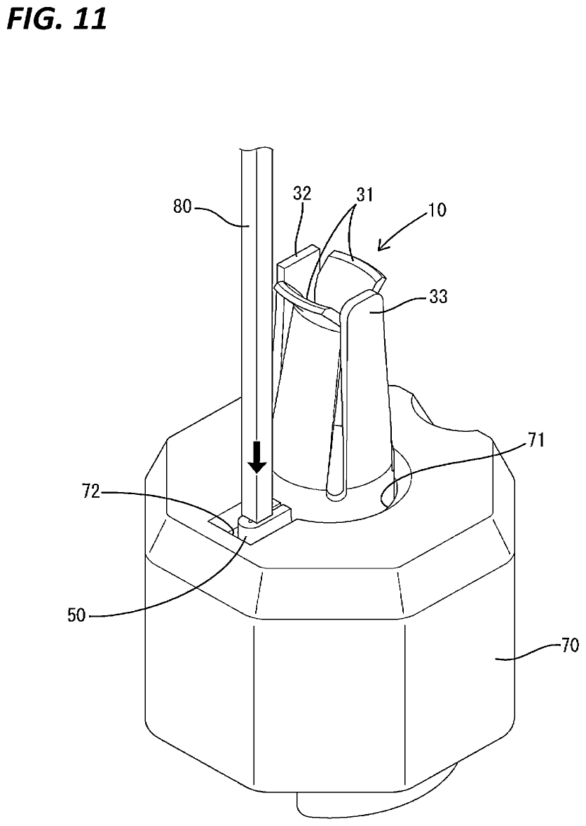

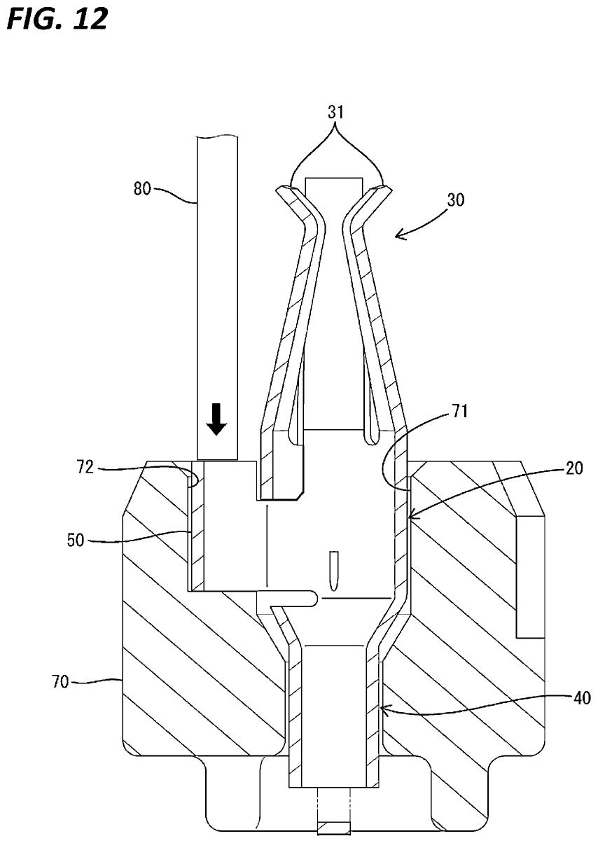

As shown in FIGS. 11 and 12, the terminal fitting 10 is assembled with the housing 70. The housing 70 has a hollow cylindrical shape. The housing 70 is, for example, made of synthetic resin. As shown in FIG. 12, the mounting portion 40 and the hollow cylindrical portion 20 are inserted into a center hole 71 of the housing 70. As shown in FIGS. 8, 11 and 12, the opening preventing portion 50 is inserted into a groove portion 72 (groove continuous with the center hole 71) of the housing 70. Thus, the rotation of the terminal fitting 10 with respect to the housing 70 can be prevented. As shown in FIGS. 11 and 12, the connecting portion 30 (the pair of resilient contact pieces 31 and the pair of slide pieces 32, 33) project further upward than the upper surface of the housing 70.

In assembling the terminal fitting 10 with the housing 70, the opening preventing portion 50 serves as a part to be pressed by a jig 80. By pressing the upper end of the opening preventing portion 50 downward by the jig 80 after the lower end side of the opening preventing portion 50 is inserted into the groove portion 72, the opening preventing portion 50 is inserted into the groove portion 72 from above.

The first part 24 of the hollow cylindrical portion 20 hardly moves radially outward by the projections 28 being press-fit into the housing 70. Thus, a contact state of the opening preventing portion 50 with the second part 25 is easily maintained and a radially outward displacement of the second part 25 is further suppressed. Therefore, the opening from the second seam 22 of the hollow cylindrical portion 20 can be further suppressed.

### Effects of Embodiment

As described above, according to the terminal fitting 10 of this embodiment, the first part 24 is provided with the opening preventing portion 50 to be brought into contact with the outer surface of the second part 25. In this way, the opening preventing portion 50 provided on the first part 24 of the hollow cylindrical portion 20 comes into contact with the outer surface of the second part 25 adjacent to the first part 24 across the second seam 22. Thus, a radially outward displacement of the second part 25 is suppressed by the contact of the second part 25 of the hollow cylindrical portion 20 with the opening preventing portion 50. Therefore, the opening from the second seam 22 of the hollow cylindrical portion 20 can be suppressed.

The terminal fitting 10 of the present disclosure is assembled with the housing 70. The opening preventing portion 50 is bent when viewed from the axial direction of the hollow cylindrical portion 20. In this way, the stiffness of the opening preventing portion 50 can be enhanced. Thus, a radially outward displacement of the second part 25 is further suppressed by the contact of the opening preventing portion 50 having a high stiffness with the second part 25 of the hollow cylindrical portion 20. Therefore, the opening from the second seam 22 of the hollow cylindrical portion 20 can be further suppressed.

According to the terminal fitting 10 of the present disclosure, the opening preventing portion 50 is inserted into the groove portion 72 provided in the housing 70 in assembling the terminal fitting 10 with the housing 70. In this way, the rotation of the terminal fitting 10 with respect to the housing 70 can be prevented.

According to the terminal fitting 10 of the present disclosure, the opening preventing portion 50 includes the inclined portion 54 inclined with respect to the outer surface of the second part 25. In this way, the position where the opening preventing portion 50 contacts the outer surface of the second part 25 is easily determined as compared to the configuration in which the opening preventing portion 50 is in surface contact with the outer surface of the second part 25 with a parallel surface. In this way, a shape variation of the terminal fitting 10 can be reduced.

According to the terminal fitting 10 of the present disclosure, the opening preventing portion 50 rises to the position near the tip of the mating terminal 60 in contact with the resilient contact pieces 31 in the axial direction of the hollow cylindrical portion 20. In this way, an impedance around the hollow cylindrical portion 20 can be changed by the opening preventing portion 50. Thus, impedance matching can be achieved between parts of the terminal fitting 10 adjacent to the mating terminal 60 and other parts not adjacent to the mating terminal 60.

According to the terminal fitting 10 of the present disclosure, the terminal fitting 10 is assembled with the housing 70 and the projections 28 to be press-fit into the housing 70 are provided on the outer surface of the first part 24 in the hollow cylindrical portion 20. In this way, the first part 24 of the hollow cylindrical portion 20 hardly moves radially outward by the projections 28 being press-fit into the housing 70. Thus, the contact state of the opening preventing portion 50 with the second part 25 is easily maintained and a radially outward displacement of the second part 25 is further suppressed. Therefore, the opening from the second seam 22 of the hollow cylindrical portion 20 can be further suppressed.

### OTHER EMBODIMENTS

The present invention is not limited to the above described and illustrated embodiment, but is represented by claims. The present invention is intended to include all changes in the scope of claims and in the meaning and scope of equivalents and also include the following embodiments.

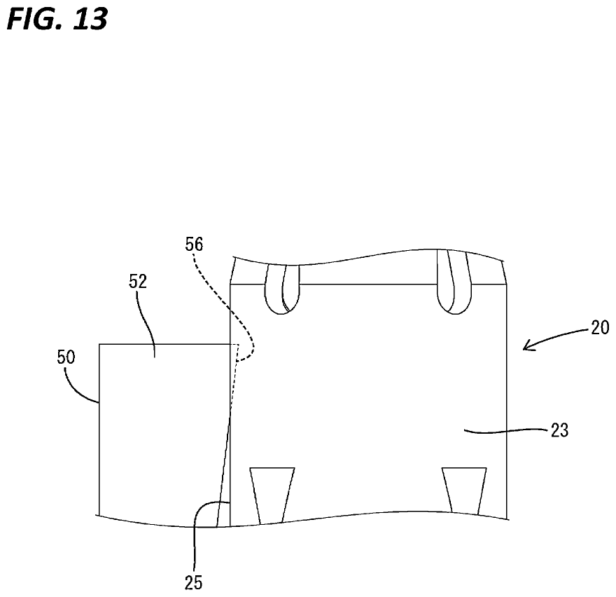

In the above embodiment, the opening preventing portion 50 may be provided with a protrusion 56 configured to bite into the outer surface of the second part 25 as shown in FIG. 13. In this way, the opening preventing portion 50 and the second part 25 are hardly shifted in position and a radially outward displacement of the second part 25 is further suppressed. Thus, the opening from the second seam 22 of the hollow cylindrical portion 20 can be further suppressed.

Although the projections 28 to be press-fit into the housing 70 are provided on the outer surface of the first part 24 in the hollow cylindrical portion 20 in the above embodiment, the projections 28 may be provided on an outer surface near the first part 24 in the hollow cylindrical portion 20.

Although the pair of resilient contact pieces 31 are provided in the above embodiment, another number of the resilient contact pieces 31 may be provided.

Although the second seam 22 has a shape along the circumferential direction in the above embodiment, the second seam 22 may be shaped to extend in another direction.

Although the opening preventing portion 50 is in contact with the outer surface of the second part 25 in the above embodiment, the opening preventing portion 50 may be closely facing the outer surface of the second part 25.

Although the inclined portion 54 is inclined with respect to the outer surface of the second part 25 parallel to the axial direction in the above embodiment, the inclined portion 54 may have a different configuration if being inclined with respect to the outer surface of the second part 25. For example, the inclined portion 54 may be inclined with respect to the second part 25 inclined with respect to the axial direction.

### LIST OF REFERENCE NUMERALS

10 . . . terminal fitting
20 . . . hollow cylindrical portion
21 . . . first seam
22 . . . second seam (seam)
23 . . . body portion
23A . . . first edge part
23B . . . second edge part
24 . . . first part (one part)
24A . . . upper end
24B . . . tip
25 . . . second part (other part)
25A . . . lower end
25B . . . tip
26 . . . crimping portion
27 . . . gap
28 . . . projection
30 . . . connecting portion
31 . . . resilient contact piece
32, 33 . . . slide piece
40 . . . mounting portion
41 . . . tapered portion
42 . . . peripheral wall portion
43 . . . leg portion
50 . . . opening preventing portion
51 . . . first plate portion
52 . . . second plate portion
53 . . . bent portion
54 . . . inclined portion
55 . . . projecting portion
56 . . . protrusion
60 . . . mating terminal
70 . . . housing
71 . . . center hole
72 . . . groove portion
80 . . . jig
L . . . axis
S1, S2 . . . slit

1. A terminal fitting, comprising:
a hollow cylindrical portion; and
a plurality of resilient contact pieces cantilevered from the hollow cylindrical portion, the hollow cylindrical portion being formed by bending a plate material such that a seam is exposed on an outer peripheral surface,
the hollow cylindrical portion including two parts adjacent across the seam, and
one of the parts being provided with an opening preventing portion in contact with or closely facing an outer surface of the other part.

2. The terminal fitting of claim 1, wherein:
the terminal fitting is assembled with a housing, and
the opening preventing portion is bent when viewed from an axial direction of the hollow cylindrical portion.

3. The terminal fitting of claim 2, wherein the opening preventing portion is inserted into a groove portion provided in the housing in assembling the terminal fitting with the housing.

4. The terminal fitting of claim 1, wherein the opening preventing portion includes an inclined portion inclined with respect to the outer surface of the other part.

5. The terminal fitting of claim 1, wherein the opening preventing portion is provided with a protrusion configured to bite into the outer surface of the other part.

6. The terminal fitting of claim 1, wherein the opening preventing portion rises to a position near a tip of a mating terminal in contact with the resilient contact pieces in an axial direction of the hollow cylindrical portion.

7. The terminal fitting of claim 1, wherein:
the terminal fitting is assembled with a housing, and
a projection to be press-fit into the housing is provided on an outer surface of the one part or an outer surface near the one part in the hollow cylindrical portion.
